(19) United States
(12) Patent Application Publication
(10) Pub. No.: US 2012/0124524 A1
(43) Pub. Date: May 17, 2012

(54) Quick Data Share

(75) Inventor: Dafna Frank Szarfman, Beit Itzhak (IL)

(73) Assignee: Microsoft Corporation, Redmond, WA (US)

(21) Appl. No.: 12/946,001

(22) Filed: Nov. 15, 2010

(51) Int. Cl. G06F 15/16; G06F 3/048

(52) U.S. Cl. 715/843; 709/206

(57) ABSTRACT

The subject disclosure is directed towards allowing a phone or other mobile device, or a computer user, to select some portion of content and then quickly share that selected content with a message recipient. A user selects content, and then interacts with the program that displays the content to select a recipient corresponding to a program, such as an SMS, email, instant message or social network recipient. The selected content is automatically provided to the program for sending in a message, including first launching the program if not already running. Also described is queuing selected content, such that multiple pieces of selected content may be combined and sent in a single message.

### BACKGROUND

Many users need or want to share information with another person. One way to do this is to send a file to a recipient, such as via an email attachment. To facilitate sending a file, Windows® Explorer, part of the Microsoft Windows® operating system, provides a mechanism within its user interface to a user's folders and the files. To use the mechanism, a user manipulates a mouse or the like to select one or more files or folders via Windows® Explorer, right clicks the mouse, and selects a “Send to”>“Mail recipient” option (or to another recipient, such as a fax recipient). This creates a new email message containing the attached file and/or folders, (after opening the email program if not already running), which the user may send after filling in the email address of the recipient.

While this is very efficient, users do not always want to share an entire file with another person, sometimes because the file is very large, or because it contains irrelevant or sensitive content. To send less than an entire file, in the email example, users need to open (or switch to) the email program, create a new email message, and paste the content into the email message. To add other content, the user needs to switch between the program having the content and the email program to select, copy and paste the other content into the email message, and so on, as many times as needed until the email message contains the desired content. This is not a particularly efficient way to share data.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a user interacts with a program to select content that is less than a file, and further interacts to take an action with respect to that content that is directed towards communicating that selected content to a recipient. In one aspect, the action may be to select a target recipient corresponding to a communications program, such as an SMS recipient, email recipient, instant message recipient, social network/cloud services recipient, and so on. Alternatively, the action may be to add the selected content to a target comprising a data storage queue, so that the content may be combined with other content and then sent in a single message, for example.

In one implementation, the queue may comprise storage of an operating system component, which allows sharing of the queue by various programs or program instances. For example, content may be combined from a plurality of programs, and/or different instances of a program, before being sent to a communications program and thereby to a recipient.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for performing a quick data share operation from a program in which selected data to share comprises less than an entire file.

FIG. 2 is a block diagram representing example components for performing a quick data share operation from a program via an operating system component in which selected data to share comprises less than an entire file.

FIG. 3 is a block diagram representing example components for performing a quick data share operation including programs sharing an operating system component for sending data and/or queuing data for sending from multiple sources.

FIG. 4 is a representation of a user interface may be interacted with to send selected content to a recipient.

FIG. 5 is a representation of how a user interface may be interacted with to send selected content to a recipient, which may include a queue for accumulating content to send.

FIG. 6 is a representation of how a user interface may be interacted with to add selected content to a queue or to send the queue to a recipient.

FIG. 7 is a flow diagram showing example steps that may be performed to send selected content to a recipient via a communications program.

FIG. 8 is a flow diagram showing example steps that may be performed to add selected content to queue or to a recipient via a communications program.

FIG. 9 is a block diagram representing an exemplary non-limiting computing system/operating environment, e.g., in the example of a mobile device, in which one or more aspects of various embodiments described herein can be implemented.

### DETAILED DESCRIPTION

Various aspects of the technology described herein are generally directed towards providing a data sharing mechanism that allows a user of a program to share data with another user by straightforward data selection and user interface interaction. For example, a mobile device user may select text and/or other content in one application, interact with the device/application such as to press and hold a finger on a touch-sensitive screen or a button, and have that text and/or other content inserted into an SMS message, or into the body of a new email message. A user of a personal computer may interact via a mouse or the like to do the same, select content and insert it into another application's message body, e.g., of an email or instant message.

Moreover, a user may select content to insert into a data container, referred to as a queue, and accumulate selected data into that queue with other selected content. The user may then further interact to send the queue. In this way, for example, different content selections (whether from one application or different applications) may be merged in the queue for sending in a single message.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computer and device data communication in general.

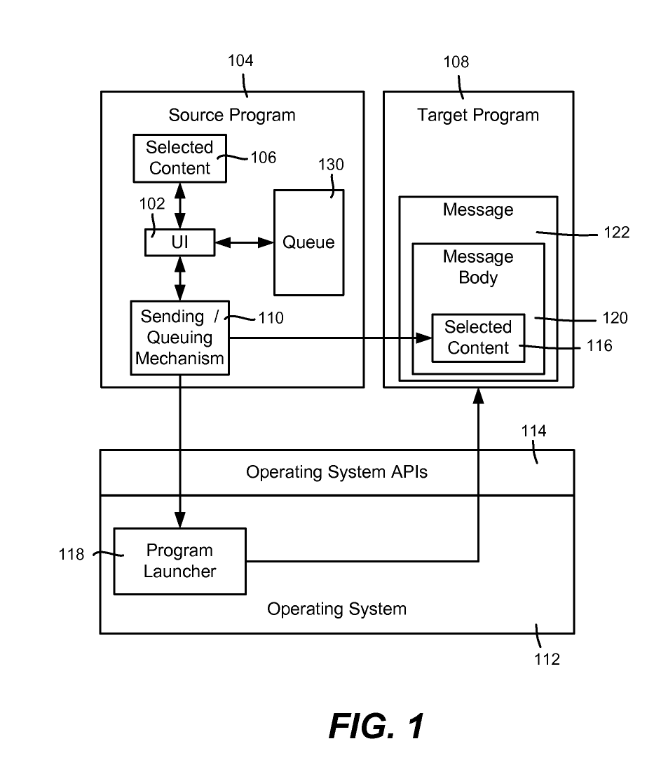

FIG. 1 shows example components of a computing device such as a mobile telephone or computer system configured to provide a user with the ability to share content, in which the content comprises less than an entire file or set of files, by sending it to another user. Through a source program user interface 102, a user interacts with the source program 104 such as a word processing or other editing application, internet browser program, or the like, to select content 106 in a known manner. Typically such content may be selected for cutting or copying to a clipboard, changing its font (in an editing application) and so on; however the technology described herein provides a user with additional options directed towards sending selected content to a target program 108, and from that program 108 to a user-specified recipient.

As represented in FIG. 1, based upon user interaction (described below), the selected content may be provided to a sending mechanism 110 built into the source program 104. For example, the sending mechanism 110 may provide one or more options (made visible via the user interface 102) for choosing a communications program to send the content. After the content is selected, the sending mechanism 110 may be invoked by further user interaction, such as by holding down a finger/button on a mobile telephone screen/keyboard, right clicking a mouse, via a key combination, voice command, gesture, shaking a mobile device, or by any other suitable actuation means. In one alternative, a modified “Paste Special” option may paste content from the clipboard to a “Send to”-selected target program.

The sending (also queuing, as described below) mechanism 110 may then interface with the operating system 112 through an API set 114 in a known manner to invoke and/or provide a copy of the selected content 116 to the target program 108, including launching (block 118) the program or program instance if not already running. This results in the target program 108 incorporating the copy of the selected content 116 into the message body 120 of a message 122. The user may then send the message 122 as appropriate for the device, content and recipient, e.g., SMS, MMS, email, instant message or social network/cloud service communication.

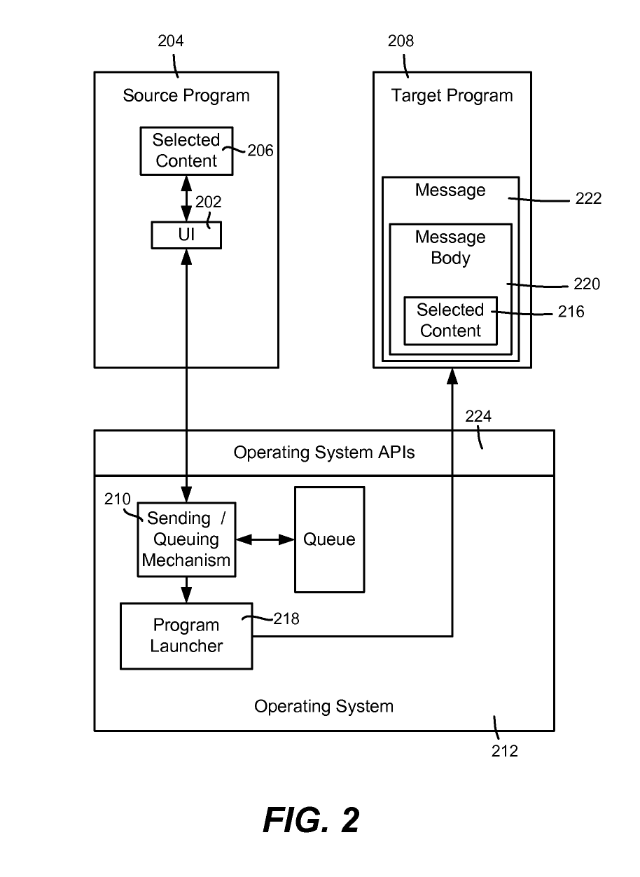

FIG. 2 is an alternative embodiment similar to that of FIG. 1, except that the functionality and structure of the sending/queuing mechanism 210 is built into the operating system 212. In general, this provides for shared usage by multiple applications and other components, (similar to cut/copy/paste, where any program may leverage the system clipboard). The user interface 202 of the source program is coded to include the “Send to” option, which when chosen as described below, calls an API of the operating system API set 224 that invokes the sending mechanism 210. The other components are like those of FIG. 1, and are shown with a “2xx” instead of a “1xx” label.

Turning to queuing aspects, there is provided a queue 130 (FIG. 1) or 230 (FIG. 2), comprising a data store that allows a user to queue multiple content selections to be inserted into a message. Various ways to add data to the queue are described below, along with ways to invoke a target program to insert the queued content into a message for sending. Note that some programs allow selection of multiple pieces of content, (e.g., Microsoft® Word allows selection of multiple pieces of the content via the mouse while holding down the control key), however not all programs allow this, and this is a somewhat limited feature; the queue allows for multiple content selection by allowing selection and queuing at different times.

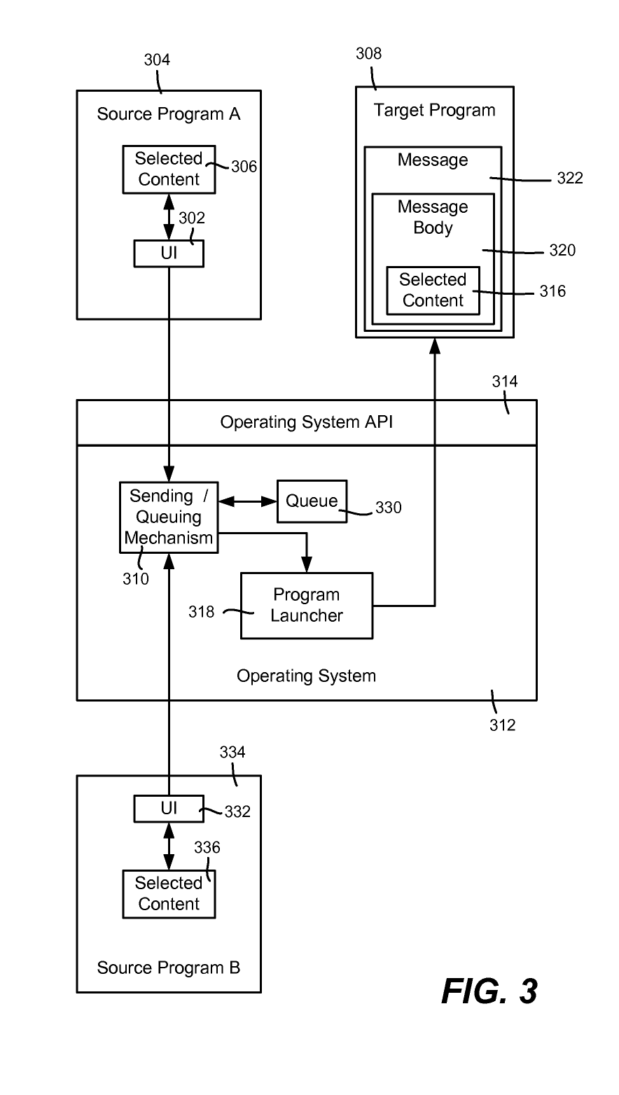

Moreover, in another alternative represented in FIG. 3, a shared queue 330 may be used, e.g., as maintained in the operating system. The shared queue 330 may have selected content 306 and 336 added to it from more than one program, e.g., programs 304 and 334, including different programs and/or different instances of the same program. The other components are like those of FIG. 2, and are shown with a “3xx” instead of a “2xx” label. It is also feasible to have multiple queues (not shown), such as one per program type, or one per program instance, for example.

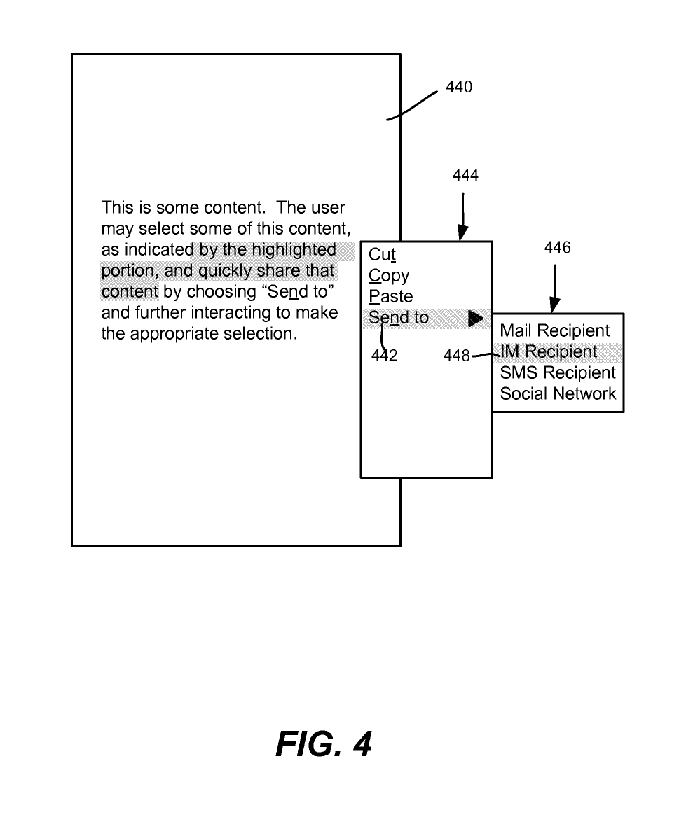

FIG. 4 shows an example program user interface for sending content. In FIG. 4, a user interacts with displayed content 440 to select some amount of it, comprising text in this example, which is highlighted in an appropriate way to indicate its selection. The user then further interacts to obtain the “Send to” option 442. In this example, this option is shown in a pop-up menu 444, and, for example, may be obtained by holding a pointer or finger onto a touch sensitive screen, holding a button, using one or more keyboard keys, right clicking and so forth. Further interaction allows the user to distinguish between the “Send to” option and other options on the menu 444, such as to tap the “Send to” option, use a button, cursor or other key, key combination, hover over “Send to” and so on. Via another pop-up menu 446 or the like, the user may then select a target program, which in this example is an IM (instant messaging) program 448. The IM program is then provided with the selected content, including launching the program if not already running.

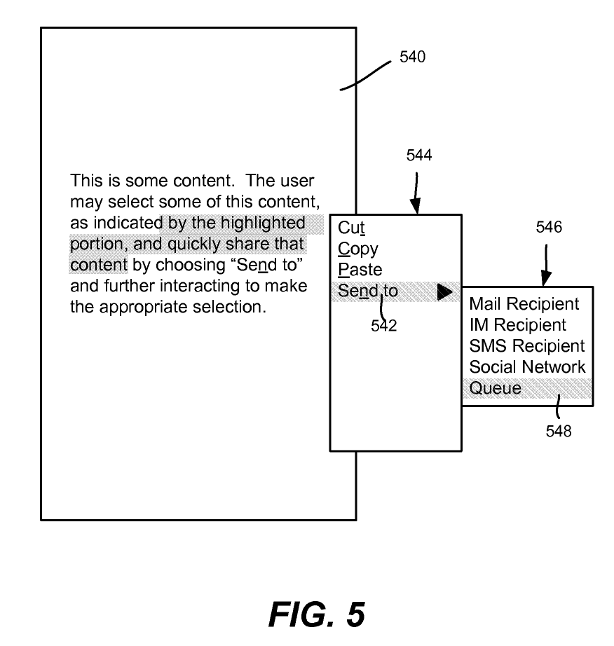

FIG. 5 is similar to FIG. 4, except that one of the possible targets is the queue 130, 230 or 330 (FIGS. 1-3). Selecting the “Queue” option 548 (in any suitable way) adds the selected content into the queue, e.g., appended after any content that may already be queued. The queue may then be sent to a target program by any suitable mechanism, including a mechanism in the source program and/or in the target program. For example, a target program may allow interaction to load the queue's contents. A “paste special”>“Queue” option may be provided in a program to “paste” content from the queue rather than from the clipboard, and so on.

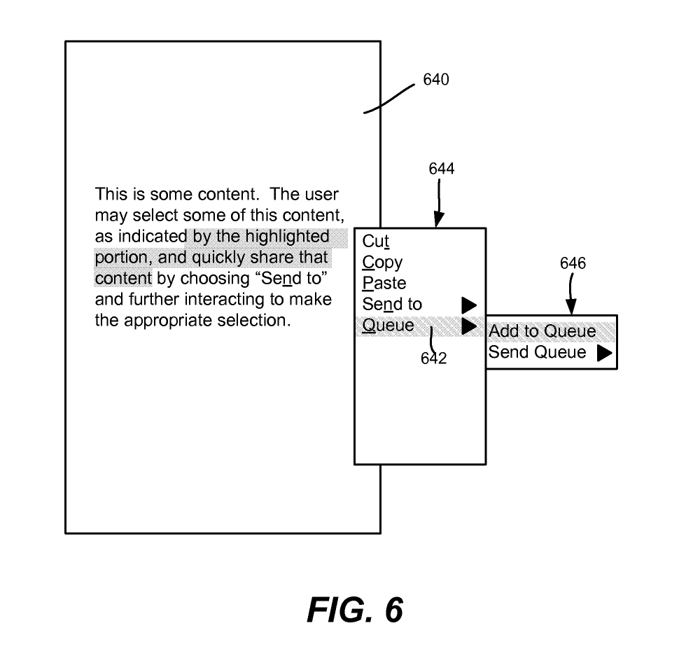

FIG. 6 shows another alternative, in which the queue option 642 appears on the menu 644 that provides options for interacting with the selected content. In other words, the queue appears as an action (verb) that may be taken rather than a target (noun) to select. In the example of FIG. 6, via a further menu 646, a user may choose to add the selected text to the queue, or send the queue (e.g., if not empty) to a target, such as to one of the targets shown in the menu 446 of FIG. 4.

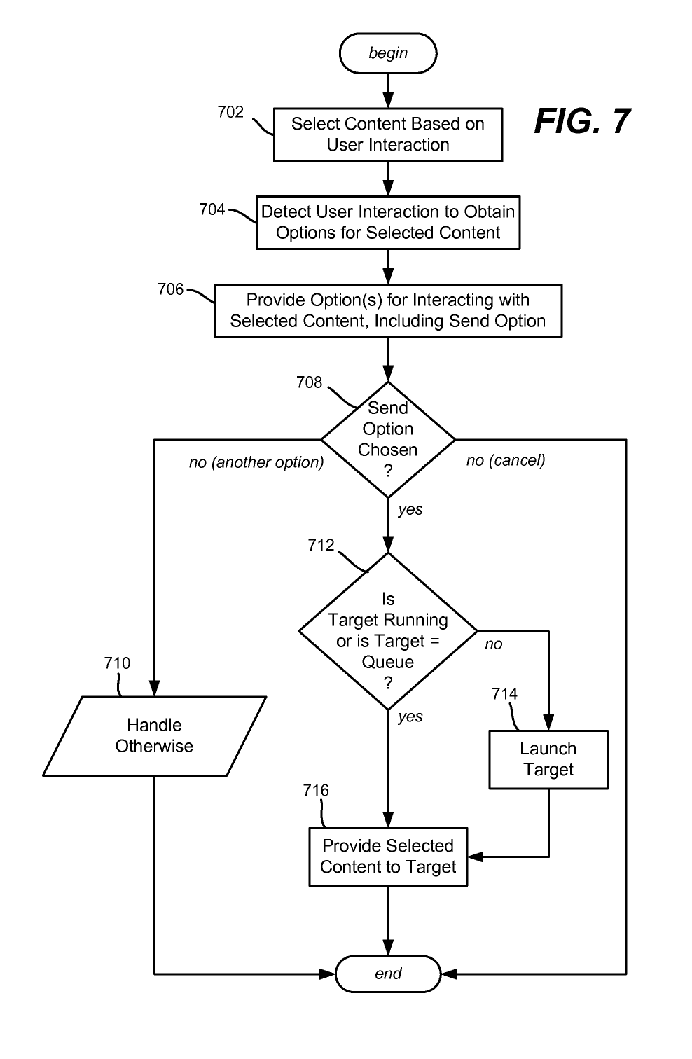

FIG. 7 is a flow diagram showing example steps representing how the user interface, queue and sending mechanisms may be used in an implementation that corresponds to FIG. 4 or FIG. 5. Step 702 represents the user selecting content. Step 704 represents detecting that the user wants to do something with that content, with the options for interacting with the selected content displayed via step 706. In this example, steps 704 and 706 correspond to the menu 444 (FIG. 4) or 544 (FIG. 5) being displayed.

Step 708 represents detecting the interaction with the options provided for the content. In this example, the user may not choose an option and cancel out of this process (at least for now), or may choose an option other than “Send to” at step 708. Such another option, such as cut/copy/paste and possible others provided by the program (including any not yet developed), are represented as being handled at block 710.

If the user chooses the “Send to” option, step 712 is performed. In general, step 712 will branch to step 714 to launch the program unless the target program is already running or the target is the queue. Step 716 provides the content to the target, e.g., queuing it or passing it to the program along with a command or the like to open a new message for sending.

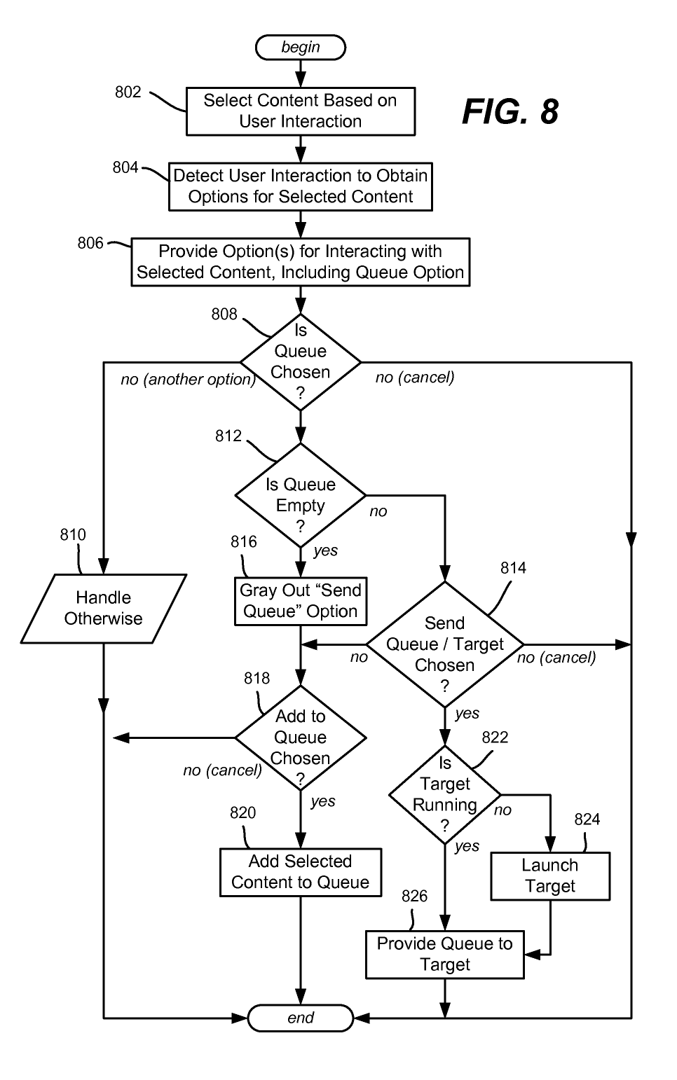

FIG. 8 is a flow diagram showing example steps representing how the user interface, queue and sending mechanisms may be used in an implementation that corresponds to the user interface of FIG. 6. Steps 802, 804 and 806 are similar to those described above with reference to FIG. 7, and are not described again for brevity except to note that step 806 further provides a Queue option, e.g., on the menu 644 of FIG. 6.

Step 808 represents detecting the interaction with the options provided for the content. In this example, the user may not choose an option and cancel out of this process (at least for now), or may choose an option other than “Queue” at step 808. Such another option, such as cut/copy/paste (and possibly the “Send to” option described above with reference to FIG. 7), along with possible others provided by the program (including any not yet developed), are represented as being handled at block 810.

If the user chooses the “Queue” option, step 812 is performed. In general, if the queue is empty, the user is not given an option to send the queue, which may be reflected in the “Send Queue” option's appearance, e.g., it may be grayed out on the menu 646 (or possibly not shown) as exemplified via block 816. Thus, if the queue option is chosen while the queue is empty, the user can only add the selected content to the queue or cancel this option, as represented via steps 818 and 820. If the queue is not empty, the user may also cancel at this time, or add the selected content to the queue via steps 818 and 820, or may choose to send the queue at step 814.

If the user chooses to send the queue at step 814, steps 822, 824 and 826 will be performed in this example to provide the queued content to the target for sending, similar to that generally described above with reference to FIG. 7. Note however that step 826 provides the contents of the queue to the selected target, rather than the selected program content.

### Exemplary Operating Environment

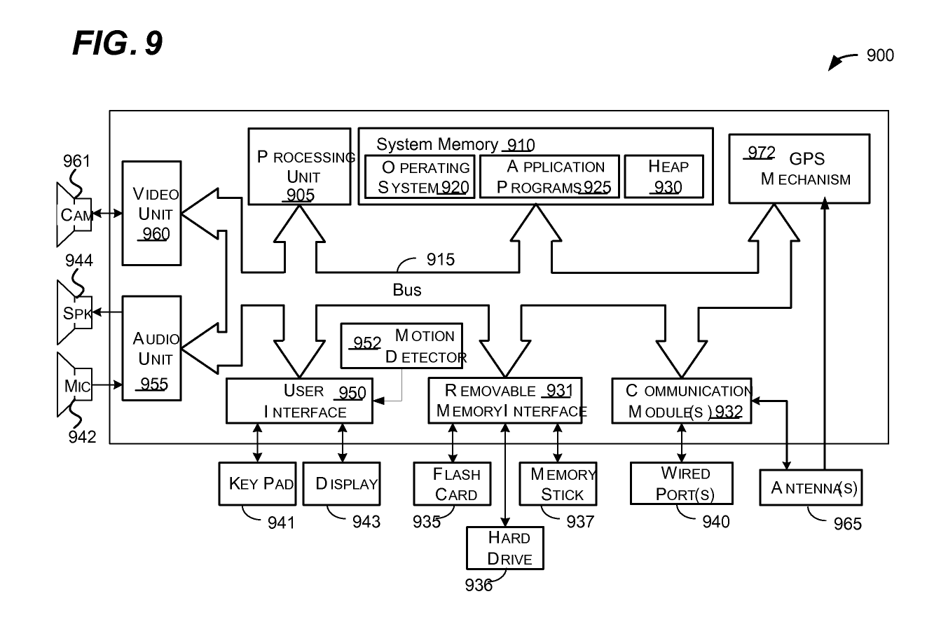

FIG. 9 illustrates an example of a suitable mobile device 900 on which aspects of the subject matter described herein may be implemented. The mobile device 900 is only one example of a device and is not intended to suggest any limitation as to the scope of use or functionality of aspects of the subject matter described herein. Neither should the mobile device 900 be interpreted as having any dependency or requirement relating to any one or combination of components illustrated in the exemplary mobile device 900.

With reference to FIG. 9, an exemplary device for implementing aspects of the subject matter described herein includes a mobile device 900. In some embodiments, the mobile device 900 comprises a cell phone, a handheld device that allows voice communications with others, some other voice communications device, or the like. In these embodiments, the mobile device 900 may be equipped with a camera for taking pictures, although this may not be required in other embodiments. In other embodiments, the mobile device 900 comprises a personal digital assistant (PDA), hand-held gaming device, notebook computer, printer, appliance including a set-top, media center, or other appliance, other mobile devices, or the like. In yet other embodiments, the mobile device 900 may comprise devices that are generally considered non-mobile such as personal computers, servers, or the like.

Components of the mobile device 900 may include, but are not limited to, a processing unit 905, system memory 910, and a bus 915 that couples various system components including the system memory 910 to the processing unit 905. The bus 915 may include any of several types of bus structures including a memory bus, memory controller, a peripheral bus, and a local bus using any of a variety of bus architectures, and the like. The bus 915 allows data to be transmitted between various components of the mobile device 900.

The mobile device 900 may include a variety of computer-readable media. Computer-readable media can be any available media that can be accessed by the mobile device 900 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 900.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, WiFi, WiMAX, and other wireless media. Combinations of any of the above should also be included within the scope of computer-readable media.

The system memory 910 includes computer storage media in the form of volatile and/or nonvolatile memory and may include read only memory (ROM) and random access memory (RAM). On a mobile device such as a cell phone, operating system code 920 is sometimes included in ROM although, in other embodiments, this is not required. Similarly, application programs 925 are often placed in RAM although again, in other embodiments, application programs may be placed in ROM or in other computer-readable memory. The heap 930 provides memory for state associated with the operating system 920 and the application programs 925. For example, the operating system 920 and application programs 925 may store variables and data structures in the heap 930 during their operations.

The mobile device 900 may also include other removable/non-removable, volatile/nonvolatile memory. By way of example, FIG. 9 illustrates a flash card 935, a hard disk drive 936, and a memory stick 937. The hard disk drive 936 may be miniaturized to fit in a memory slot, for example. The mobile device 900 may interface with these types of non-volatile removable memory via a removable memory interface 931, or may be connected via a universal serial bus (USB), IEEE 9394, one or more of the wired port(s) 940, or antenna(s) 965. In these embodiments, the removable memory devices 935-937 may interface with the mobile device via the communications module(s) 932. In some embodiments, not all of these types of memory may be included on a single mobile device. In other embodiments, one or more of these and other types of removable memory may be included on a single mobile device.

In some embodiments, the hard disk drive 936 may be connected in such a way as to be more permanently attached to the mobile device 900. For example, the hard disk drive 936 may be connected to an interface such as parallel advanced technology attachment (PATA), serial advanced technology attachment (SATA) or otherwise, which may be connected to the bus 915. In such embodiments, removing the hard drive may involve removing a cover of the mobile device 900 and removing screws or other fasteners that connect the hard drive 936 to support structures within the mobile device 900.

The removable memory devices 935-937 and their associated computer storage media, discussed above and illustrated in FIG. 9, provide storage of computer-readable instructions, program modules, data structures, and other data for the mobile device 900. For example, the removable memory device or devices 935-937 may store images taken by the mobile device 900, voice recordings, contact information, programs, data for the programs and so forth.

A user may enter commands and information into the mobile device 900 through input devices such as a key pad 941 and the microphone 942. In some embodiments, the display 943 may be touch-sensitive screen and may allow a user to enter commands and information thereon. The key pad 941 and display 943 may be connected to the processing unit 905 through a user input interface 950 that is coupled to the bus 915, but may also be connected by other interface and bus structures, such as the communications module(s) 932 and wired port(s) 940. Motion detection 952 can be used to determine gestures made with the device 900.

A user may communicate with other users via speaking into the microphone 942 and via text messages that are entered on the key pad 941 or a touch sensitive display 943, for example. The audio unit 955 may provide electrical signals to drive the speaker 944 as well as receive and digitize audio signals received from the microphone 942.

The mobile device 900 may include a video unit 960 that provides signals to drive a camera 961. The video unit 960 may also receive images obtained by the camera 961 and provide these images to the processing unit 905 and/or memory included on the mobile device 900. The images obtained by the camera 961 may comprise video, one or more images that do not form a video, or some combination thereof.

The communication module(s) 932 may provide signals to and receive signals from one or more antenna(s) 965. One of the antenna(s) 965 may transmit and receive messages for a cell phone network. Another antenna may transmit and receive Bluetooth® messages. Yet another antenna (or a shared antenna) may transmit and receive network messages via a wireless Ethernet network standard.

Still further, an antenna provides location-based information, e.g., GPS signals to a GPS interface and mechanism 972. In turn, the GPS mechanism 972 makes available the corresponding GPS data (e.g., time and coordinates) for processing.

In some embodiments, a single antenna may be used to transmit and/or receive messages for more than one type of network. For example, a single antenna may transmit and receive voice and packet messages.

When operated in a networked environment, the mobile device 900 may connect to one or more remote devices. The remote devices may include a personal computer, a server, a router, a network PC, a cell phone, a media playback device, a peer device or other common network node, and typically includes many or all of the elements described above relative to the mobile device 900.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor, comprising, detecting user interaction with a program, in which the user interaction identifies selected content presented by that program that is less than an entire file to which the content belongs, detecting further interaction directed towards providing the selected content to a target, and in response, providing the selected content to the target, including launching the target if the target corresponds to another program that is not running.

2. The method of claim 1 wherein providing the selected content to the target comprises adding the selected content to a queue.

3. The method of claim 1 wherein providing the selected content to the target comprises appending the selected content to other queued content in a queue.

4. The method of claim 3 further comprising, detecting a request to send the queue, and in response, sending the selected content and the other queued content to a communications program configured to communicate a message containing the selected content and the other queued content.

5. The method of claim 3 further comprising, adding the other queued content to the queue in response to detecting other interaction in another program or another program instance.

6. The method of claim 1 wherein detecting the further interaction includes presenting an interactive menu, the menu including an option for sending the selected content to the target.

7. The method of claim 1 wherein detecting the further interaction includes presenting an interactive menu, the menu including an option for adding the selected content to a queue, or including an option for sending the queue, or both an option for adding the selected content to a queue and an option for sending the queue.

8. In a computing environment, a system comprising, a sending and queuing mechanism, the sending and queuing mechanism configured to detect user interaction with respect to selected content, in which the selected content is less than an entire file to which the selected content belongs, and based upon the user interaction, to provide the selected content for sending in a message of a communications program or to add selected content to a queue.

9. The system of claim 8 wherein the sending and queuing mechanism is incorporated into a program that displays content for selection and includes a user interface that detects the user interaction.

10. The system of claim 8 wherein the queue comprises program storage corresponding to a program that displays content for selection and includes a user interface that detects the user interaction.

11. The system of claim 8 wherein the sending and queuing mechanism comprises an operating system component that is called by a program that displays content for selection.

12. The system of claim 8 wherein the queue comprises storage coupled to the operating system component.

13. The system of claim 12 wherein the queue contains content stored from a plurality of programs.

14. The system of claim 12 wherein the queue contains content stored from a plurality of program instances.

15. The system of claim 8 wherein the sending and queuing mechanism operates to launch the communications program if the selected content is provided for sending in a message of the communications program, and the communications program is not running.

16. The system of claim 8 wherein the sending and queuing mechanism includes a user interface configured to detect user interaction with respect to selected content, the user interface comprising a menu in which options are provided for sending the selected content in a message or adding selected content to a queue.

17. The system of claim 8 wherein the sending and queuing mechanism and communications program comprise executable code that runs in a mobile telephone, a mobile device, or a personal computer.

18. One or more computer-readable media having computer-executable instructions, which when executed perform steps, comprising, running a program by which selected content is chosen, in which the content is less than an entire file, detecting that the user wants to take an action with respect to the selected content, providing a menu that displays possible actions for the user to take with respect to the selected content, then menu including an action by which the selected content is provided to a user-selectable target.

19. The one or more computer-readable media of claim 18 having further computer-executable instructions comprising adding the selected content to a queue when the user-selectable target comprises a queue.

20. The one or more computer-readable media of claim 18 having further computer-executable instructions comprising providing the selected content to a communications program queue when the user-selectable target corresponds to communicating the content to a recipient.
